(19) United States
(12) Patent Application Publication
(10) Pub. No.: US 2005/0134526 A1
(43) Pub. Date: Jun. 23, 2005

(54) Configurable tiled emissive display

(76) Inventors: Patrick Willem, Oostende (BE); Nele Dedene, Houthalen-Helchteren (BE); Herbert Van Hille, Cambridge, MA (US); Robbie Thielemans, Nazareth (BE)

Correspondence Address: BARNES & THORNBURG, P.O. BOX 2786, CHICAGO, IL, 60690-2786, US

(21) Appl. No.: 10/743,966

(22) Filed: Dec. 23, 2003

(51) Int. Cl. G09G 5/00

(52) U.S. Cl. 345/1.3

(57) ABSTRACT

The present invention relates to a configurable emissive display tile, e.g. an organic light-emitting diode (OLED) display tile and associated methods for use in a tiled large-screen display application. The OLED tile assembly of the present invention is capable of operating either as an autonomous display or, alternatively, may operate within a set of OLED display tiles forming a larger tiled display. An embodiment of an OLED tile assembly (100) according to an embodiment of the present invention is shown in FIG. 1C, including a power supply (158), a cooling system with cooling fans (160) and cooling blocks (146) and a control system, comprising a control board (154) with processor, an OLED board (142) and a substrate (140). It furthermore includes a digital video interface and an automatic addressing system The present invention further includes a method of initial assembly, automatic configuration, and calibration of the tiled OLED display and a method of replacing, adding, or removing one or more OLED tile assemblies in a larger tiled display.

### FIELD OF THE INVENTION

The present invention relates to a modular large-screen emissive display such as an organic light-emitting diode (OLED) display. In particular, this invention relates to a scalable display composed of autonomous and interchangeable tiles. The present invention also provides a method for automatic configuration of a tiled emissive display such as an OLED display, and a method for replacing tiles in a tiled emissive display such as an OLED display.

### BACKGROUND OF THE INVENTION

OLED technology incorporates organic luminescent materials that, when sandwiched between electrodes and subjected to a DC electric current, produce intense light of a variety of colours. These OLED structures can be combined into the picture elements, or pixels, that comprise a display or a tile of a complete display. OLEDs are also useful in a variety of applications as discrete light-emitting devices or as the active element of light-emitting arrays or displays, such as flat-panel displays in watches, telephones, laptop computers, pagers, cellular phones, calculators, and the like. To date, the use of OLED light-emitting arrays or displays has been largely limited to small-screen applications such as those mentioned above.

The market is now, however, demanding larger displays with the flexibility to customise display sizes. For example, advertisers use standard sizes for marketing materials; however, those sizes differ based on location. Therefore, a standard display size for the United Kingdom differs from that of Canada or Australia. Additionally, advertisers at trade shows need bright, eye-catching, flexible systems that are easily portable and easy to assemble and disassemble. Still another rising market for customisable large display systems is the control room industry, in which maximum display quantity, quality, and viewing angles are critical. Demands for large-screen display applications possessing higher quality and higher light output has led the industry to turn to alternative display technologies that replace older LED and liquid crystal displays (LCDs). For example, LCDs fail to provide the bright, high light output, larger viewing angles, and high resolution and speed requirements that the large-screen display market demands. By contrast, OLED technology promises bright, vivid colours in high resolution and at wider viewing angles. However, the use of OLED technology in large-screen display applications, such as outdoor or indoor stadium displays, large marketing advertisement displays, and mass-public informational displays, is only beginning to emerge.

Large screen displays are often modular or tiled displays made from smaller modules or displays that are then combined into larger tiles. These tiled displays are manufactured as a complete unit that can be further combined with other tiles to create displays of any size and shape. However, the individual tiles forming a tiled display are typically not capable to operate as a full display alone. What is needed is an OLED tile that may operate standing alone as an autonomous display or alternatively may operate within a set of tiles to form a larger tiled display. Consequently, what is further needed is a scalable OLED display tile that reduces system architecture complexity and a method of associating and configuring an OLED tile automatically upon installation. Lastly, what is needed is a scalable OLED display tile that allows distributed and parallel processing, thereby reducing the complexity of the overall system processing requirements.

An example tiled display is described in WO 99/41732, entitled, “Tiled electronic display structure.” The '732 patent application describes a tiled display device that is formed from display tiles having pixel positions defined up to the edge of the tiles. Each pixel position has an OLED active area that occupies approximately twenty-five percent of the pixel area. Each tile includes a memory that stores display data and pixel driving circuitry that controls the scanning and illumination of the pixels on the tile. The pixel driving circuitry is located on the back side of the module and connections to pixel electrodes on the front side of the tile are made by vias that pass through portions of selected ones of the pixel areas that are not occupied by the active pixel material. The tiles are formed in two parts—an electronics section and a display section. Each of these parts includes connecting pads that cover several pixel positions. Each connecting pad makes an electrical connection to only one row electrode or column electrode. The connecting pads on the display section are electrically connected and physically joined to corresponding connecting pads on the electronics section to form a complete tile. Each tile has a glass substrate on the front of the tile. Black matrix lines are formed on the front of the glass substrate and the tiles are joined by mullions that have the same appearance as the black matrix lines.

Although the tiled display described in the '732 patent application provides a means for interconnecting tiles to create a large display system, '732 patent application fails to provide a scalable OLED display tile that reduces system architecture complexity and a method of associating and configuring an OLED tile automatically upon installation.

Furthermore, the tiled OLED display needs a high bandwidth for calculations done in a central processor.

### SUMMARY OF THE INVENTION

It is an object of the present invention to provide an emissive display that is scalable and reduces the complexity of the overall system processing requirements as well as a method of operating the same.

It is another object of this invention to provide a scalable emissive display tile that reduces system architecture complexity as well as a method of operating the same.

It is yet another object of this invention to provide a way of associating and configuring an emissive tile, e.g. an OLED tile, automatically upon installation.

The above objectives are accomplished by a method and device according to the present invention.

In a first aspect, the present invention relates to a tiled emissive, e.g. an OLED display for displaying an image. The tiled emissive, e.g. OLED display comprises a plurality of OLED tile assemblies mechanically coupled together, and a processing means for performing real-time calculations with respect to the image to be displayed. The processing means according to the present invention is a distributed processing means which is distributed over the plurality of emissive display, e.g. OLED tile assemblies, so that each emissive display, e.g. OLED tile assembly is suitable for handling a different portion of the image for performing real-time calculations. A tile can automatically configure its operational characteristics, and the tiles associate/communicate with one another upon installation, to form an integral display. The tiles have electrical connections for access to the distributed processing means.

The tiled emissive, e.g. OLED display can have distributed processing means which are suitable for performing image upscaling or downscaling as necessary at each emissive display, e.g. OLED tile assembly. For the image upscaling or downscaling a high-level scaling algorithm can be used. This high-level scaling algorithm may be a 100% accurate scaling algorithm.

The distributed processing means of the plurality of emissive display, e.g. OLED tile assemblies comprise processing elements operating in parallel.

An emissive display, e.g. OLED tile assembly may be provided with a data input and/or a data output connection for receiving data from or transmitting data to another emissive display, e.g. OLED tile assembly via any of suitable connection topology, e.g. a feed-and-drop line, a multi-line connection, a daisy chain connection or a star connection. Furthermore, the emissive display, e.g. OLED tile assemblies may be provided with a power input and/or a power output connection for receiving power from or transmitting power to another emissive display, e.g. OLED tile assembly via any of a feed-and drop line, a multi-line connection, a daisy chain connection or a star connection or there may be a separate power connection.

The emissive display, e.g. OLED tile assemblies may be provided with a single connector allowing to combine both power and data transmission.

The emissive display, e.g. OLED tile assemblies may furthermore be provided with a local memory means for storing configuration data. The memory means is preferably a non-volatile memory. The emissive display, e.g. OLED tile display may furthermore be adapted so that the emissive display, e.g. OLED tile assemblies can be repaired while the other tiles continue working, i.e. the tiles may be hot-swap enabled. This can mean that e.g. the controller or the power supply in a tile may be replaced without disconnecting the power and data connectors. In this way the internal parts of the tile may be replaced without the other tiles having to cease their operation.

Furthermore, the tiled emissive display, e.g. OLED display according to the invention may have an adjustable size, e.g. by addition or subtraction of tiles.

In a second aspect, the invention relates to a method of automatically configuring a tiled emissive display, e.g. OLED display comprising a plurality of emissive display, e.g. OLED tile assemblies mechanically coupled together, whereby the tiled emissive display, e.g. OLED display is intended for displaying an image. The method comprises assigning to each emissive display, e.g. OLED tile assembly a unique address for use in steering content and communication data, distributing to each emissive display, e.g. OLED tile assembly display co-ordinates that designate which portion of the image to be displayed it will show, configuring the emissive display, e.g. OLED tile assemblies by reading, for each emissive display, e.g. OLED tile assembly, configuration data stored in a memory device local to the emissive display, e.g. OLED tile assembly, and using this information in a distributed processing means local to the emissive display, e.g. OLED tile assembly to configure the resolution of the emissive display, e.g. OLED tile assembly.

The method furthermore may comprise, before assigning to each emissive display, e.g. OLED tile assembly a unique address, detecting the presence of the emissive display, e.g. OLED tile assemblies in the tiled emissive display, e.g. OLED display.

Additionally, calibrating the emissive display, e.g. OLED tile assemblies to match overall display brightness and/or to correct individual pixel non-uniformity may be performed.

Furthermore, the method may comprise, before assigning to each emissive display, e.g. OLED tile assembly a unique address, mechanically assembling and activating the tiled emissive display, e.g. OLED display. This mechanical assembling may include providing a feed-and-drop line, a daisy chain connection, a multi-line connection or a star connection for data and/or power from one emissive display, e.g. OLED tile assembly to another.

In a third aspect, the present invention relates to a method of replacing at least one emissive display, e.g. OLED tile assembly in a tiled emissive display, e.g. OLED display intended for displaying an image. The method comprises mechanically replacing at least one emissive display, e.g. OLED tile assembly in the tiled emissive display, e.g. OLED display, assigning to the at least one replaced emissive display, e.g. OLED tile assembly a unique address for use in steering content and communication data, assigning to the at least one replaced emissive display, e.g. OLED tile assembly display co-ordinates that designate which portion of the image to be displayed it will show, configuring the at least one replaced emissive display, e.g. OLED tile assembly by reading, for each replaced emissive display, e.g. OLED tile assembly, configuration data stored in a memory device local to the at least one emissive display, e.g. OLED tile assembly, and using this information in a distributed processing means local to the replaced emissive display, e.g. OLED tile assembly to configure the resolution of the emissive display, e.g. OLED tile assembly. The method may also include the step of detecting that a display tile has been removed from the tiled display and storing information with respect to that part of the image which the removed tile displayed. It further includes assigning to a new tile, the part of the image which was displayed by the removed tile.

The method furthermore may comprise calibrating the at least one replaced emissive display, e.g. OLED tile assembly to match overall display brightness and/or to correct individual pixel non-uniformity.

Before assigning the unique address, the method may include determining whether the number or arrangement of tiles has been altered. If the number or arrangement of the tiles has been altered, the method may furthermore comprise configuring the tiled emissive display, e.g. OLED display according to the above mentioned methods of configuring.

The method furthermore may include mechanically replacing at least one emissive display, e.g. OLED tile assembly whereby the connection of the different emissive display, e.g. OLED tile assemblies is restored, for data and/or power from or to at least one other emissive display, e.g. OLED tile assembly.

### BRIEF DESCRIPTION OF THE DRAWINGS

FIG. 1A is a perspective view of a viewable side of an OLED tile assembly in accordance with an embodiment of the present invention.

FIG. 1B is a perspective view of a non-viewable side of an OLED tile assembly in accordance with an embodiment of the present invention.

FIG. 1C is an exploded view of an OLED tile assembly in accordance with an embodiment of the present invention.

FIG. 2 is a cross-sectional drawing of the OLED tile assembly taken along line A-A of FIG. 1B.

FIG. 3 is a cross-sectional drawing of a Detail A of FIG. 1C.

FIG. 4 is a perspective view of a single mask for use with an OLED tile assembly of the present invention.

FIG. 5A schematically illustrates a tiled OLED display and a multi-line method of signal and power distribution in accordance with an embodiment of the present invention.

FIG. 5B schematically illustrates a tiled OLED display and a daisy-chain method of signal and power distribution in accordance with an embodiment of the present invention.

FIG. 6 illustrates a functional block diagram of an OLED tile control system for use in an OLED tile assembly in accordance with an embodiment of the present invention.

FIG. 7 illustrates the overall architecture of an OLED tile control system in accordance with an embodiment of the present invention.

FIG. 8 is a flow diagram of a method of initial assembly, automatic configuration, and calibration of a tiled OLED display in accordance with an embodiment of the present invention.

FIG. 9 is a flow diagram of a method of replacing, adding, or removing one or more OLED tile assemblies in a tiled OLED display.

### DETAILED DESCRIPTION OF ILLUSTRATIVE EMBODIMENTS

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn on scale for illustrative purposes.

The present invention will be described with reference to an OLED display, especially an OLED tiled display but the present invention is not limited to OLED displays but may be used with any emissive displays, especially tiled emissive displays. Emissive displays generally comprise an array of emissive pixel elements, each pixel element or group of pixel elements being individually addressable so as to display an arbitrary image. Such displays are often described as fixed format displays to distinguish them over CRT displays. The term “fixed format” refers to the fact that addressable pixel elements at fixed positions are used to display the image. Fixed format does not mean that the displays cannot be made scalable, e.g. tiled. Suitable emissive displays include Light Emitting Diode (LED) displays, electroluminescent displays such as EL displays, Plasma displays, etc.

In the following reference will be made to OLED displays but such reference applies equally well to any emissive display. Accordingly in one aspect of the present invention, a configurable OLED display tile and associated methods for use in a tiled large-screen display application are provided. The OLED display tile according to an embodiment of the present invention is capable of operating either as an autonomous display or alternatively of operating within a set of OLED display tiles forming a larger tiled display. The present invention may also include assemblies of pixel arrays, e.g. they may be tiled displays and may comprise modules made up of tiled arrays which are themselves tiled into supermodules. Thus, the word display relates to a set of addressable pixels in an array or in groups of arrays. Several display units or tiles may be located adjacent to each other to from a larger display, i.e. multiple display elements are physically arranged side-by-side so that they can be viewed as a single image. The physical hardware implementation of the OLED display tile or OLED tile assembly of the present invention and the architecture of a larger tiled display formed by an k by l array of OLED tile assemblies provide distributed processing that has the result of a less complex display hardware and software system, thereby avoiding the need for high-bandwidth calculations by a central processor.

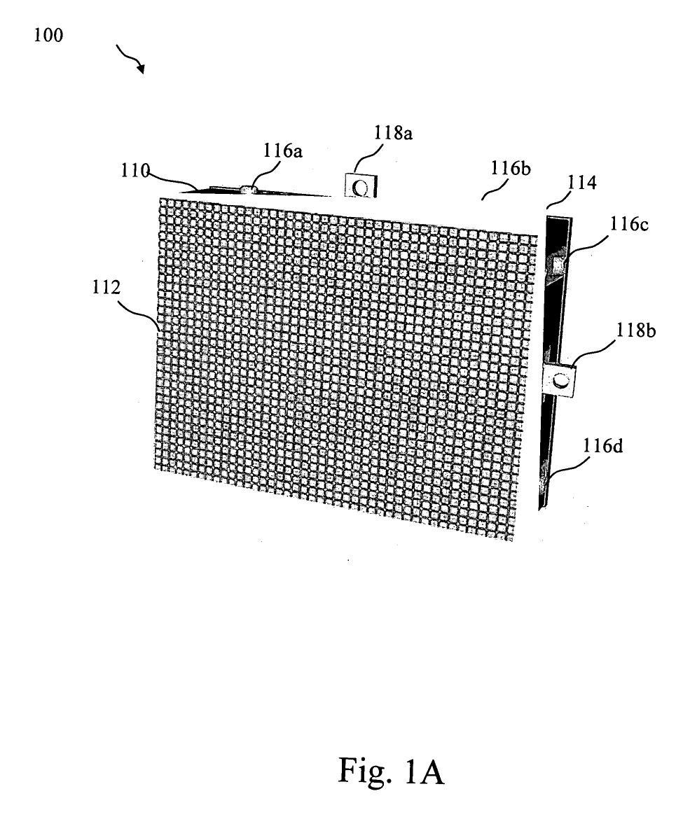

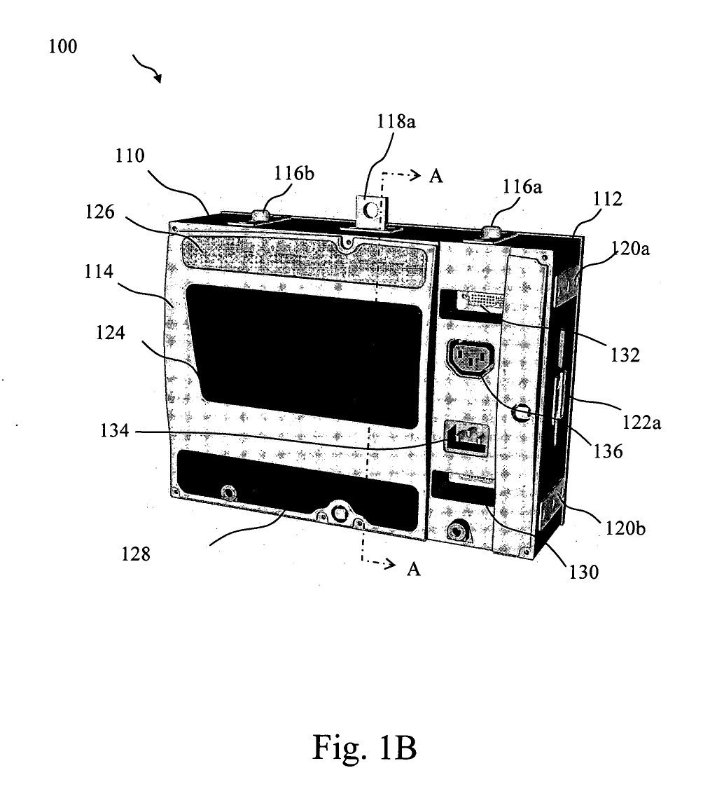

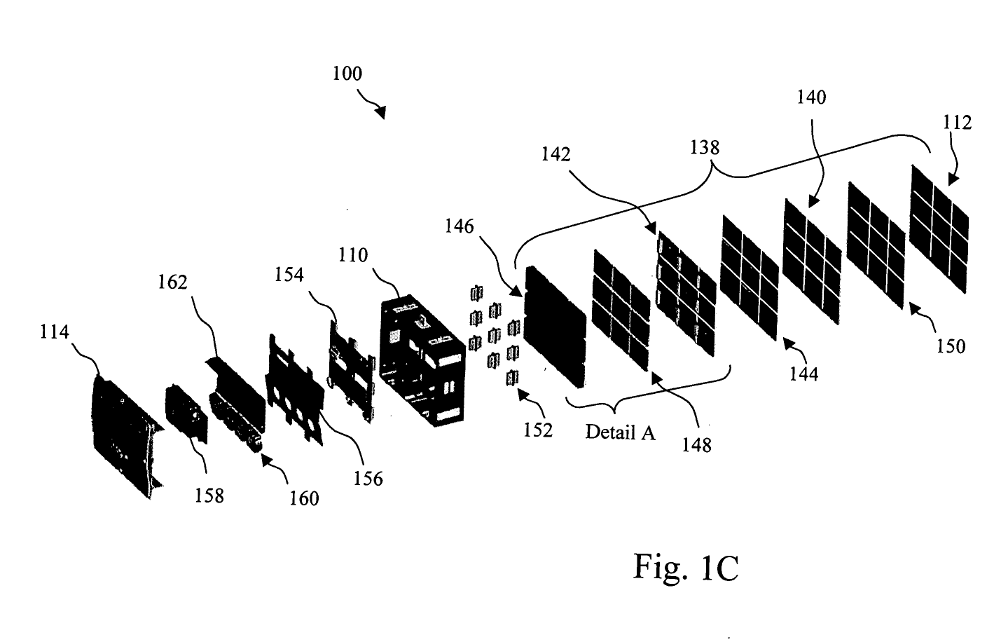

FIG. 1A is a perspective view of a viewable side of an OLED tile assembly 100 in accordance with an embodiment of the invention. OLED tile assembly 100 is suitable for use as an autonomous display or alternatively may operate within a set of OLED tile assemblies 100 to form a larger tiled display. OLED tile assembly 100 includes a precision frame 110; a plurality of masks 112; an enclosure 114; a plurality of positioning plates and pins 116 (e.g., positioning plate and pin 116a, positioning plate and pin 116b, positioning plate and pin 116c, and positioning plate and pin 116d), and a plurality of clamp elements 118 (e.g., alignment tab 118a and alignment tab 118b) disposed within precision frame 110, as shown in FIG. 1A.

FIG. 1B is a perspective view of a non-viewable side of OLED tile assembly 100 in accordance with an embodiment of the invention. In this view, it is apparent that OLED tile assembly 100 further includes a plurality of positioning plates and holes 120 (e.g., positioning plate and hole 120a, positioning plate and hole 120b), and a plurality of alignment slots 122 (e.g., alignment slot 122a), all disposed within precision frame 110. Disposed within enclosure 114 is an air inlet 124, a first air outlet 126, a second air outlet 128, a data input connector 130, a data output connector 132, a power input connector 134, and a power output connector 136, as shown in FIG. 1B.

FIG. 1C is an exploded view of OLED tile assembly 100 in accordance with an embodiment of the invention. In this view, it is apparent that OLED tile assembly 100 includes, in order from front to back, the front side being the side suitable for displaying the image, an array of OLED module assemblies 138, each further including a mask 112, a substrate 140, an OLED board 142, optionally a quantity of underfill material 144, a cooling block 146, a quantity of potting material 148, and a circular polariser 150; a plurality of connectors 152; precision frame 110; a control board 154; an assembly bracket 156; a power supply (P/S) 158 and a plurality of cooling fans 160, both of which are mounted upon assembly bracket 156; an insulation sheet 162 for P/S 158, and enclosure 114, as shown in FIG. 1C. With reference to FIG. 1A, FIG. 1B, and FIG. 1C, it is noted that OLED tile assembly 100 is sized according to the array of OLED module assemblies 138. In this example, a 3×3 array of OLED module assemblies 138 is illustrated. However, OLED tile assembly 100 is not limited to this example: the physical size of OLED tile assembly 100 and its elements may vary depending upon the configuration of an n by m array of OLED module assemblies 138, which is selectable.

With reference to FIG. 1A, FIG. 1B, and FIG. 1C, the elements of OLED tile assembly 100 are described as follows.

Precision frame 110 serves as the primary mechanical structure upon and within which all other elements of OLED tile assembly 100 are mounted. Precision frame 110 is formed of any suitably strong material, such as light metal alloys, that will support the structure of OLED tile assembly 100. Precision frame 110 is sized according to a predetermined array configuration of OLED module assemblies 138 housed within the precision frame 110. Mounted upon a first side of precision frame 110 are a first positioning plate and pin 116a and a second positioning plate and pin 116b, with a first alignment tab 118a positioned therebetween. Mounted upon a second side (adjacent to the first side) of precision frame 110 are a third positioning plate and pin and a fourth positioning plate and pin, with a second alignment tab positioned therebetween. These, however, are not visible in the perspective view of FIG. 1C. Similarly, mounted upon a third side of precision frame 110 are a first positioning plate and hole 120a and a second positioning plate and hole 120b, with a first alignment slot 122a positioned therebetween. Mounted upon a fourth side (adjacent to the third side, and not visible in FIG. 1C) of precision frame 110 are a third positioning plate and hole and a fourth positioning plate and hole, with a second alignment slot positioned therebetween.

Enclosure 114 also can comprise 2 separate parts: i.e. one part with the air inlet and outlets and one part with the data and power input and output connectors. This feature combined with the correct internal arrangements in the tile allows to replace e.g. the controller or the power supply in a tile, without disconnecting the power and data connectors. When the internal parts of the tile that has to be repaired are replaced, all the other tiles will continue working. This feature of the display is called “hot swap capability”. The hot swap capability is not shown in any of the drawings.

Positioning plates and pins 116, clamp elements 118, positioning plates and holes 120, and alignment slots 122 are typically formed of stainless steel. Positioning plates and pins 116, clamp elements 118, positioning plates and holes 120, and alignment slots 122 serve as alignment and locking mechanisms for use when a plurality of OLED tile assemblies 100 are assembled in the k by l array to form a larger tiled display. More specifically, positioning plates and pins 116 and clamp elements 118 of one OLED tile assembly 100 align and mechanically couple to positioning plates and holes 120 and alignment slots 122, respectively, of an adjacent OLED tile assembly 100.

Each mask 112 is sized accordingly and placed on the viewable side of each respective OLED module assembly 138. Collectively, masks 112 are used to hide the seams between substrates 140 within OLED tile assembly 100 when assembled. Furthermore, masks 112 are used to hide the seams between OLED tile assemblies 100 within the k by l array of OLED tile assemblies 100 that form a larger tiled display. Each mask 112 forms a grid of dark lines; thus, physical gaps between elements become impossible to see because they disappear among the other lines. The pitch of the dark lines in the mask is usually equal to the pixel pitch or to a multiple of the pixel pitch. Further details of mask 112 are found in reference to FIG. 4.

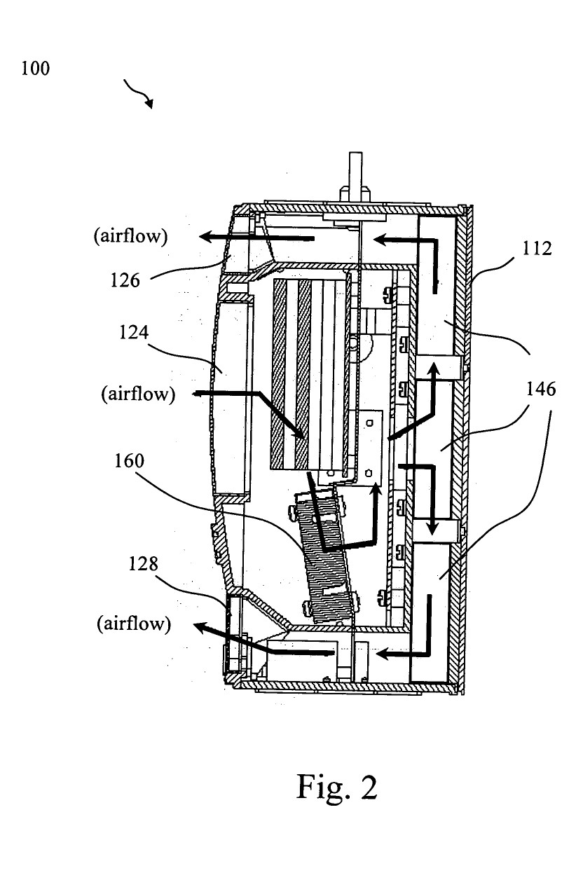

Enclosure 114 forms the structure of the non-viewable side of OLED tile assembly 100. Enclosure 114 is formed of any suitably strong material, such as light metal alloy, and is mechanically attached to one side of precision frame 110. Disposed within enclosure 114 are air inlet 124, first air outlet 126, and second air outlet 128, as shown in FIG. 1B. Air inlet 124, first air outlet 126, and second air outlet 128 are formed of any suitable material that is permeable to air, such as an iron or aluminium grid. Air inlet 124 serves as the ambient air intake to OLED tile assembly 100, for cooling the OLED tile assembly 100. By contrast, first air outlet 126 and second air outlet 128 serve to exhaust warm air generated by OLED tile assembly 100 during operation. The movement of air into and out of OLED tile assembly 100 is due to the action of cooling fans 160. Further details of the airflow within OLED tile assembly 100 are illustrated in reference to FIG. 2.

Also disposed within enclosure 114 are data input connector 130, data output connector 132, power input connector 134, and power output connector 136, as shown in FIG. 1B.

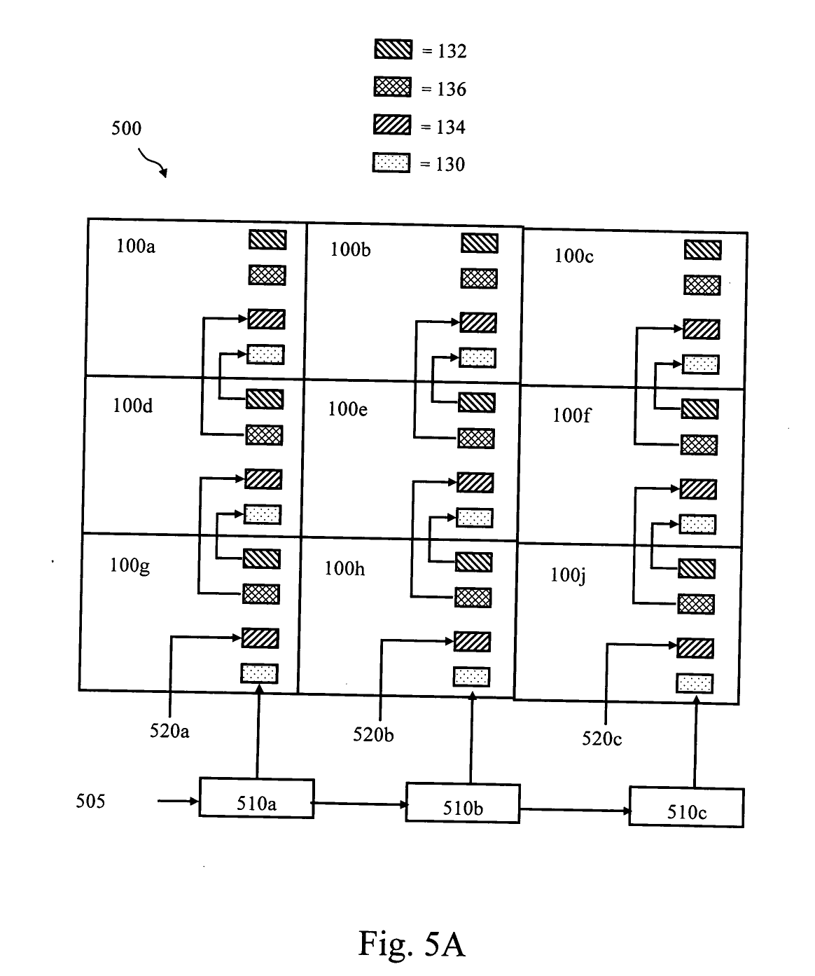

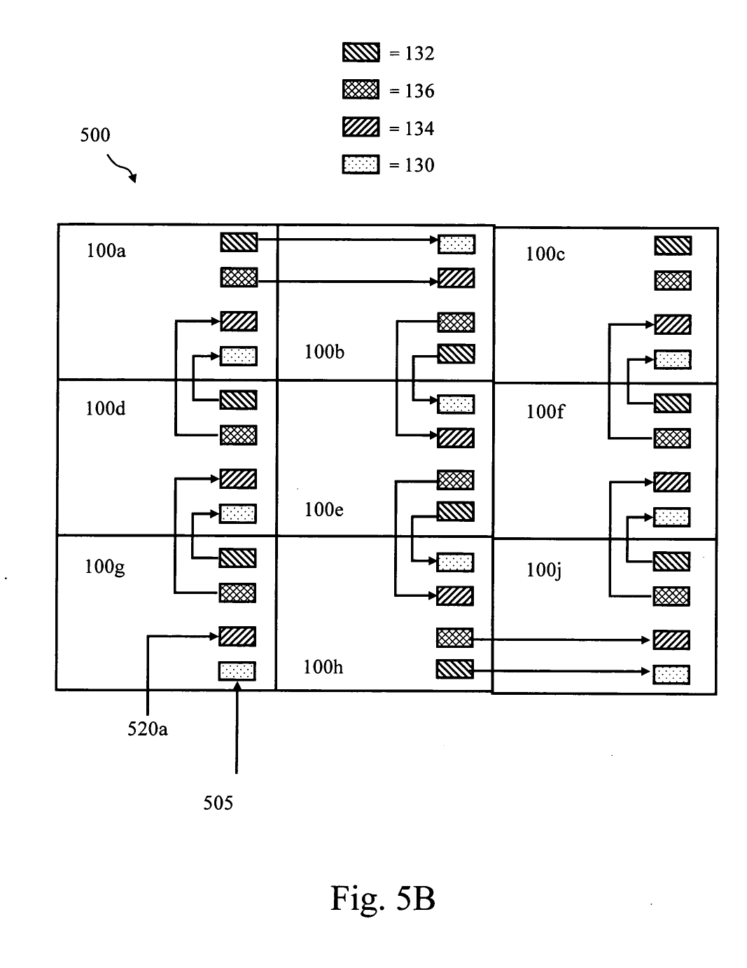

Data input connector 130 and data output connector 132 are conventional signal connectors, such as MOLEX, DVI-digital 74320-3004. Data input connector 130 provides an electrical connection for receiving serial video data signals containing the current video frame information to be displayed on OLED tile assembly 100 and for receiving serial control data signals from a general processor (not shown). If applicable, OLED tile assembly 100 subsequently re-transmits serial video and control data signals to a next, preferably adjacent, OLED tile assembly 100 via data output connector 132. Power input connector 134 and power output connector 136 are conventional power connectors capable of handling up to e.g. 265 AC volts and 10 amps, such as power input connector IEC60320-C14 or power output connector IEC60320-C13. Power input connector 134 provides an electrical connection for receiving AC input power to OLED tile assembly 100. If applicable, OLED tile assembly 100 subsequently transmits this AC power to a next, preferably adjacent, OLED tile assembly 100 via power output connector 136. The AC voltage from power input connector 134 is bussed directly to power output connector 136. An illustration of distribution methods of signal and power distribution within a tiled OLED display is found with reference to FIG. 5A and FIG. 5B. For compactness issues, the data and power connections can also be integrated in one connector block.

Each OLED module assembly 138, which includes mask 112, substrate 140, OLED board 142, optional underfill material 144, cooling block 146, potting material 148, and circular polariser 150, is representative of a structure for forming a common-anode, passive-matrix, OLED array with associated drive circuitry. In the common-anode configuration, a current source is arranged between each individual cathode of the OLED devices and ground, while the anodes of the OLED devices are electrically connected in common to a positive power supply. As a result, the current and voltage are completely independent of one another and small voltage variations do not result in current variations eliminating light output variations due to voltage variations. Its elements are described as follows.

Substrate 140 of OLED module assembly 138 is formed of a non-conductive, transparent material, such as glass for example. Deposited upon substrate 140 is a pixel array formed of a plurality of addressable discrete OLED devices or pixels. Those skilled in the art will appreciate that the OLED devices for forming graphics display are typically arranged logically in rows and columns to form an OLED array or matrix. The term “logically arranged in rows and columns” refers to the fact that the actual display does not have to be formed in Cartesian co-ordinates but may be provided in other co-ordinate systems such as polar. However, in all of these systems there are equivalents to rows and columns, e.g. arcs of circles and radii. These are therefore logically arranged in rows and columns even if they are not physically arranged in such a manner. Substrate 140 further includes electrical contacts to and from anode and cathode lines, which respectively are electrically connected to the anodes of a row of OLED pixels and to the cathodes of a column of OLED pixels.

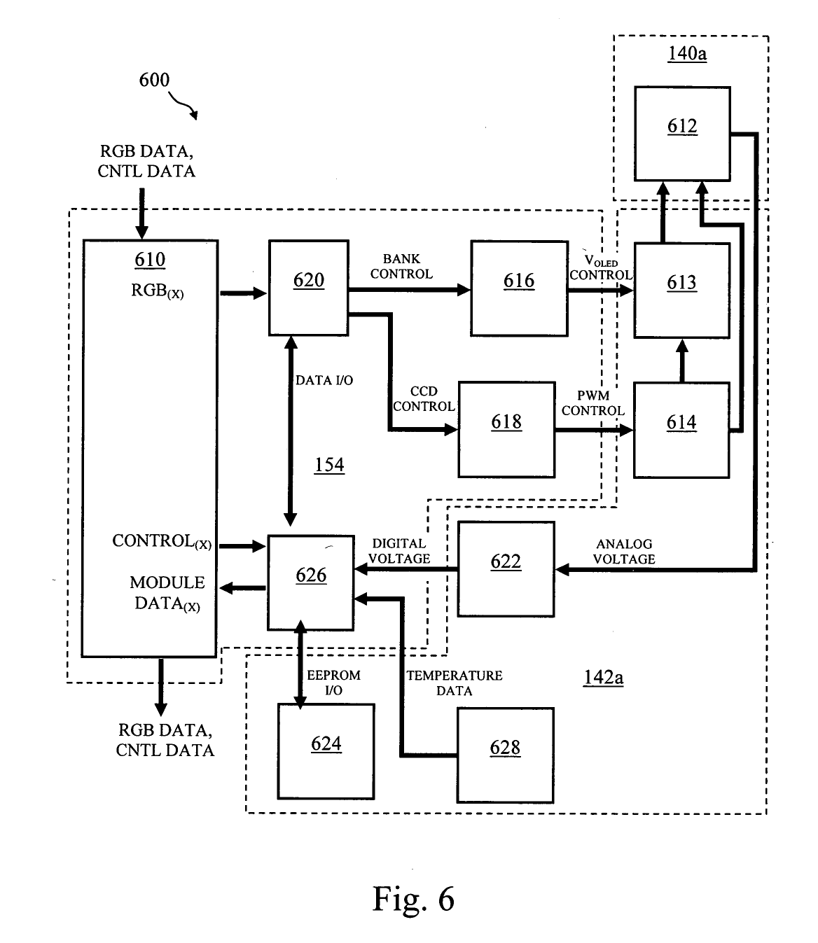

OLED board 142 of OLED module assembly 138 is a conventional printed circuit board (PCB) formed of a material such as ceramic or FR4 or FR5, i.e. known glass laminates widely used for subtractive printed circuit board fabrication because of their ability to meet a wide variety of processing conditions. On the printed circuit board are mounted the drive circuitry devices. A functional block diagram of OLED board 142 is described in reference to FIG. 6. OLED board 142 includes wiring to facilitate electrical signal and power connections to and from the pixel array upon substrate 140. OLED board 142 further includes a set of counter contacts for providing electrical connections to substrate 140, for example via well-known solder bump technology (not shown). Through an alignment procedure, substrate 140 is placed on top of the prepared OLED board 142. Substrate 140 and OLED board 142 are subsequently placed into an oven, thereby melting the solder and forming a solder joint between substrate 140 and OLED board 142.

Optionally, underfill material 144 is used in OLED module assembly 138, which is electrically non-conductive and thermally conductive material, such as liquid epoxy material, that is inserted between substrate 140 and OLED board 142. Underfill material 144 can be applied as a liquid after substrate 140 and OLED board 142 have been connected to each other by solder joints. Underfill material 144 can be used to remove the air gap between these solder joints, thereby increasing the heat transfer between substrate 140 and OLED board 142 and thus improving the cooling. After application as a liquid, underfill material 144 is cured, thereby forming a solid material. Furthermore, due to the presence of underfill material 144, thermal stresses on the solder joints are redistributed among substrate 140, OLED board 142, underfill material 144, and the solder, thereby increasing the life of the solder joints by mitigating fatigue. Although the presence of underfill material 144 improves the performance of OLED module assembly 138, underfill material 144 is optional and, thus, may be omitted from the structure of OLED module assembly 138.

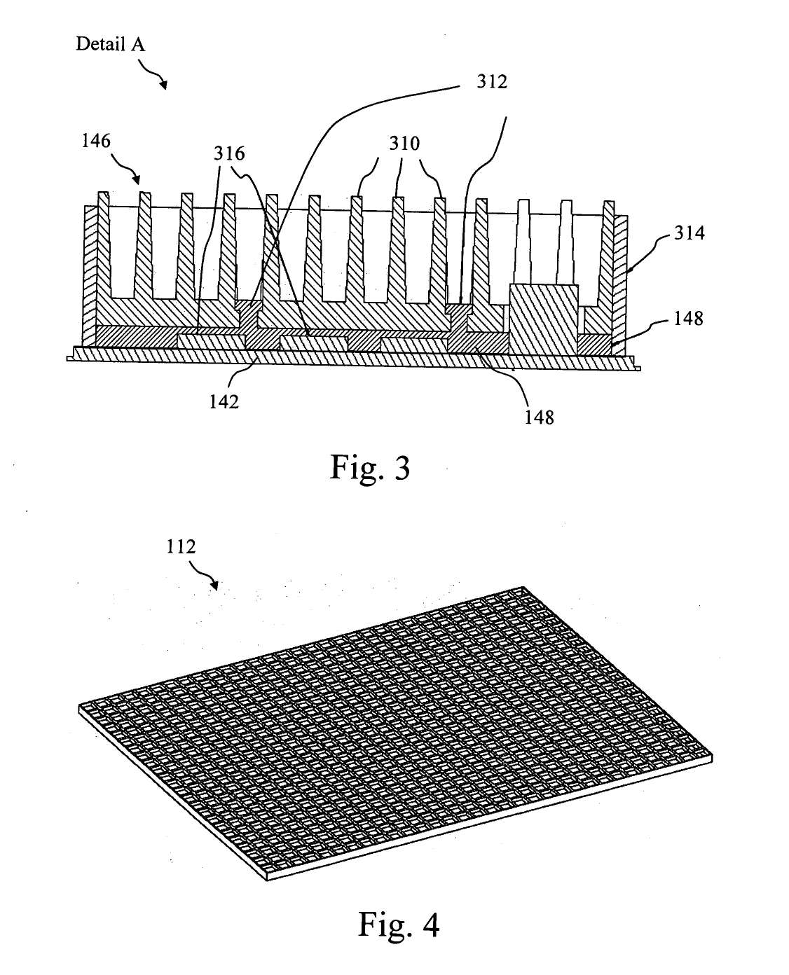

Cooling block 146 of OLED module assembly 138 is a conventional heat sink device formed of thermally conductive material, such as aluminium, that is thermally bonded to OLED board 142 via potting material 148. Potting material 148 is a thermally conductive material, such as Loctite product Hysol EE1087 in combination with the hardener HD 3561. Potting material 148 is injected between OLED board 142 and cooling block 146 in order to improve the heat transfer and thus the cooling therebetween. Potting material 148 is injected as a liquid and is then cured to form a solid material. Further details of cooling block 146 and potting material 148 are found in reference to FIG. 3.

Circular polariser 150 of OLED module assembly 138 is mounted between substrate 140 and mask 112. Circular polariser 150 is a well-known optical device formed of a material, such as e.g. polycarbonate. Circular polariser 150 is an absorptive polariser that allows one type of circular polarisation (left or right) to transmit largely unattenuated, while it will absorb the other circular polarisation (right or left). Circular polariser 150 is used to reduce the amount of ambient light reflections on substrate 140. The ambient light is unpolarised and therefore part of it is directly absorbed by the circular polariser and the other part is converted into left (or right) circular polarised light by circular polariser 150. This transmitted left (or right) circular polarised light reflects on substrate 140 and is converted into right (or left) circular polarised light. This right (left) circular polarised light is absorbed by circular polariser 150. Circular polariser 150 increases the contrast of the display. An example of an absorbing circular polariser 150 is a Nitto Denko model SEG1425DU+NRF QF01A.

Connectors 152 are standard connectors for transferring signals and power from control board 154 to the plurality of OLED boards 142. There is one connector 152 per OLED module assembly 138. Connectors 152 must be dimensioned to span the distance between OLED boards 142 and control board 154 while taking into account the thickness of cooling blocks 146. In doing so, clearance holes are provided within precision frame 110 and cooling blocks 146 to allow connectors 152 to pass therethrough. An example of connector 152 is a BergStak Connector, product number: 61082-06YABC.

Control board 154 is a conventional printed circuit board (PCB) formed of a material such as ceramic or FR4, upon which are mounted the local processing and control devices needed to operate the n by m array of OLED module assemblies 138. In general, control board 154 performs pre-processing tasks, such as gamma correction, gamma adjustment of the incoming signal, colour and light calibration according to measurements done at manufacture with a spectral camera and a colour meter, and image scaling algorithms. A functional block diagram of control board 154 is described in reference to FIG. 6.

Assembly bracket 156 is a mechanical structure for supporting both control board 154, P/S 158 and cooling fans 160 within OLED tile assembly 100, as shown in FIG. 1C. Assembly bracket 156 is formed of any suitably strong material, such as steel.

P/S 158 is a conventional power supply that includes a programmable AC-to-DC converter (not shown) and a programmable voltage regulator (not shown). The voltage is regulated per OLED tile assembly 100. An AC input voltage of between 170 and 265 volts is supplied to P/S 158 via power input connector 134 (see FIG. 1B). A DC output voltage of 5 to 25 volts at a maximum current of 7 amps is provided to control board 154 and to OLED module assemblies 138. Furthermore, the DC power from P/S 158 is bussed to OLED module assemblies 138 in a passive manner by control board 154.

Cooling fans 160 are conventional DC fans capable of providing a volume rate of airflow of between 2 and 5 cubic feet per minute (cfm) in order to maintain an operating temperature within OLED tile assembly 100 of between 10 and 50° C. An example of cooling fan 160 is a Delta Electronics model BFB0505M. The number of cooling fans 160 mounted within OLED tile assembly 100 depends upon the n by m array configuration of OLED module assemblies 138 and the associated control board 154 and P/S 158 requirements. P/S 158 provides DC power to cooling fans 160. P/S 158 also controls cooling fans 160.

Insulation sheet 162 is an insulation sheet for the power supply, as shown in FIG. 1C. Insulation sheet 162 is formed of a suitable material, such as mica.

FIG. 2 is a cross-sectional drawing of OLED tile assembly 100 taken along line A-A of FIG. 1B. FIG. 2 is intended to illustrate the airflow within OLED tile assembly 100 and shows that air is drawn into OLED tile assembly 100 via air inlet 124 as a result of the action of cooling fans 160. The airflow subsequently passes over cooling blocks 146 (see FIG. 3) and subsequently exhausts via first air outlet 126 and second air outlet 128 as shown in FIG. 2. In this way, heat generated by the active components of OLED module assemblies 138, control board 154, and P/S 158 is removed.

FIG. 3 is a cross-sectional drawing of a Detail A of FIG. 1C. FIG. 3 is intended to illustrate the injection process of potting material 148 between OLED board 142 and cooling block 146. Detail A illustrates that cooling block 146 further includes a plurality of fins 310 that are typical of a heat-removing device. Also included within cooling block 146 is a plurality of injection points 312 that inject potting material 148 in liquid form. A potting calibre 314 is mounted along the perimeter edge of cooling block 146 and serves as a form for containing potting material 148. Lastly, Detail A illustrates a plurality of components 316 mounted upon OLED board 142. Components 316 are active and/or passive electrical components that generate heat when operating, such as the OLED devices and switches for example. Upon injection, potting material 148 fills the gap between cooling block 146 and OLED board 142 as well as the gaps between components 316, thereby forming a heat transfer medium for efficiently transferring heat away from OLED board 142 and components 316.

FIG. 4 is a perspective view of a single mask 112 with OLED tile assembly 100 of the present invention. Mask 112 is a custom made device that is sized according to the size of its associated OLED module assembly 138. Mask 112 may be formed of polyamide or polycarbonate, and the grid pattern formed therein is determined by the pixel pitch of its associated OLED module assembly 138. In this example, the grid of mask 112 is designed for use with a 24×32 pixel array.

FIG. 5A and FIG. 5B illustrate two possibilities for signal distribution in a tiled OLED display 500. FIG. 5A shows a multi-line distribution method of signal and power distribution in accordance with the invention. Tiled OLED display 500 is representative of a k by l array of OLED tile assemblies 100. In this example, a 3×3 array is pictured. More specifically, FIG. 5A illustrates that tiled OLED display 500 includes, for example, OLED tile assemblies 100a, 100b, 100c, 100d, 100e, 100f, 100g, 100h, and 100j. It is further illustrated that each OLED tile assembly 100 includes its associated data input connector 130, data output connector 132, power input connector 134, and power output connector 136. Lastly, tiled OLED display 500 further includes a plurality of data reclockers 510, for example, data reclocker 5100a, data reclocker 5100b, and data reclocker 5100c.

The multi-line distribution method of signal distribution is described as follows. A DATA IN signal 505 from a central processing unit (not shown) is supplied to an input of data reclocker 5100a. DATA IN signal 505 is representative of serial video and control data.

Data reclocker 5100a subsequently re-transmits this serial video and control data to one OLED tile assembly 100 as well as to a next data reclocker 510, i.e., in the example given, to an input of data reclocker 5100b and to data input connector 130 of OLED tile assembly 100g. Similarly, data reclocker 5100b transmits the received serial video and control data signal to an input of data reclocker 5100c and to data input connector 130 of OLED tile assembly 100h. Finally, data reclocker 5100c transmits the received serial video and control data to data input connector 130 of OLED tile assembly 100j. This way, the DATA IN signal 505 is distributed to all OLED tiles assemblies 100 of one row of the tiled OLED display 500. It is to be noted that the data links in the tiled OLED display 500 are bidirectional, so it is also possible to place data reclockers 5100a, 5100b, and 5100c on top of tiled OLED display 500, instead of placing them at the bottom, thus feeding the DATA IN signal 505 to data input connectors 130 of OLED tile assemblies 100a, 100b, 100c. These bidirectional links also make it possible to pass the DATA IN signal 505 from the end of one column to the beginning of the neighbouring column. It is likewise to be noted that the terms “row” and “column” are interchangeable, meaning that the data reclockers may distribute the DATA IN signal 505 to all OLED tiles assemblies 100 of one column of the tiled OLED display 500.

Subsequently, the serial video and control data is transferred from one OLED tile assembly 100 to the next OLED tile assembly 100 along a same column if the DATA IN signal 505 was fed to all OLED tile assemblies 100 of a row, or to the next OLED tile assembly 100 along a same row if the DATA IN signal 505 was fed to all OLED tile assemblies 100 of a column. Hereinafter, the situation of FIG. 5A is further described, i.e. the case in which the DATA IN signal 505 was fed to all OLED tile assemblies 100 along a same row. For example and with reference to FIG. 5A, the serial video and control data is transferred from OLED tile assembly 100g to OLED tile assembly 100d via an electrical connection between data output connector 132 of OLED tile assembly 100g and data input connector 130 of OLED tile assembly 100d, then from OLED tile assembly 100d to OLED tile assembly 100a via an electrical connection between data output connector 132 of OLED tile assembly 100d and data input connector 130 of OLED tile assembly 100a. Likewise, the serial video and control data is transferred from OLED tile assembly 100h to OLED tile assembly 100e via an electrical connection between data output connector 132 of OLED tile assembly 100h and data input connector 130 of OLED tile assembly 100e, then from OLED tile assembly 100e to OLED tile assembly 100b via an electrical connection between data output connector 132 of OLED tile assembly 100e and data input connector 130 of OLED tile assembly 100b. Lastly, the serial video and control data is transferred from OLED tile assembly 100j to OLED tile assembly 100f via an electrical connection between data output connector 132 of OLED tile assembly 100j and data input connector 130 of OLED tile assembly 100f, then from OLED tile assembly 100f to OLED tile assembly 100c via an electrical connection between data output connector 132 of OLED tile assembly 100f and data input connector 130 of OLED tile assembly 100c. In each case, the serial video and control data is retransmitted by control board 154 of each OLED tile assembly 100.

The multi-line distribution method of power distribution is accomplished by AC power connections from one OLED tile assembly 100 to the next OLED tile assembly 100 along the same column or row as follows. A POWER INPUT signal 520a from a mains power supply (not shown) is supplied to OLED tile assembly 100g via an electrical connection to power input connector 134 of OLED tile assembly 100g. AC power is then transferred from OLED tile assembly 100g to OLED tile assembly 100d via an electrical connection between power output connector 136 of OLED tile assembly 100g and power input connector 134 of OLED tile assembly 100d. AC power is then subsequently also transferred from OLED tile assembly 100d to OLED tile assembly 100a via an electrical connection between power output connector 136 of OLED tile assembly 100d and power input connector 134 of OLED tile assembly 100a. Likewise, a POWER INPUT signal 520b from the mains power supply (not shown) is supplied to OLED tile assembly 100h via an electrical connection to power input connector 134 of OLED tile assembly 100h. AC power is then transferred from OLED tile assembly 100h to OLED tile assembly 100e via an electrical connection between power output connector 136 of OLED tile assembly 100h and power input connector 134 of OLED tile assembly 100e. AC power is then transferred from OLED tile assembly 100e to OLED tile assembly 100b via an electrical connection between power output connector 136 of OLED tile assembly 100e and power input connector 134 of OLED tile assembly 100b. Lastly, a POWER INPUT signal 520c from the mains power supply (not shown) is supplied to OLED tile assembly 100j via an electrical connection to power input connector 134 of OLED tile assembly 100j. AC power is then transferred from OLED tile assembly 100j to OLED tile assembly 100f via an electrical connection between power output connector 136 of OLED tile assembly 100j and power input connector 134 of OLED tile assembly 100f. AC power is then transferred from OLED tile assembly 100f to OLED tile assembly 100c via an electrical connection between power output connector 136 of OLED tile assembly 100f and power input connector 134 of OLED tile assembly 100c. As mentioned previously, the AC input voltage from a power input connector 134 is simply bussed directly to power output connector 136. Equally to the distribution of the DATA IN signal 505 over the OLED tile assemblies 100, the power distribution may be performed either column-wise or row-wise.

An alternative distribution method for signal distribution is a star distribution (not represented in the drawings). The wording star distribution refers to the fact that the distribution of data signals or power occurs from the centre to the edge of the tiled OLED display 500 or vice versa. In this distribution method, the signals are transferred by a data reclocker 510 to several central OLED tile assemblies 100, each of them further transferring the data signals to tiles at further distance of the centre or the edge respectively of the tiled OLED display 500. In this way, distribution of serial video data and control data is obtained between the OLED tile assemblies from the centre assemblies 100 of the OLED tile display 500 to the edge assemblies 100 or vice versa, so that all OLED tile assemblies 100 obtain their part of the serial video data and control data. If preferred, it is also possible to obtain serial video data and control data transfer from edge assemblies to centre assemblies, i.e. starting at some of the edge assemblies and transferring to neighbouring assemblies ending in or around the centre of the display, so that all OLED tile assemblies 100 obtain their part of the serial video data and control data. In similar way, it is possible to obtain this method of distribution, i.e. star distribution, for the power distribution.

A third distribution method of both serial video and control data and power is illustrated in FIG. 5B. It shows a daisy-chain method of distribution for a tiled OLED display 500. The tiled OLED display 500 is representative of a k by l array of OLED tile assemblies 100. In this example, a 3×3 array is pictured. More specifically, FIG. 5B illustrates that tiled OLED display 500 includes, for example, OLED tile assemblies 100a, 100b, 100c, 100d, 100e, 100f, 100g, 100h, and 100j. It is further illustrated that each OLED tile assembly 100 includes its associated data input connector 130, data output connector 132, power input connector 134, and power output connector 136.

The daisy-chain distribution method of signal distribution is described as follows. A DATA IN signal 505, representative of serial video and control data, from a central processing unit (not shown) is supplied to an input of one OLED tile assembly 100, i.e. in the example given to data input connector 130 of OLED tile assembly 100g. Subsequently, the serial video and control data is transferred from one OLED tile assembly 100 to a next, neighbouring OLED tile assembly 100. For example and with reference to FIG. 5B, the serial video and control data is transferred from OLED tile assembly 100g to OLED tile assembly 100d via an electrical connection between data output connector 132 of OLED tile assembly 100g and data input connector 130 of OLED tile assembly 100d, then from OLED tile assembly 100d to OLED tile assembly 100a via an electrical connection between data output connector 132 of OLED tile assembly 100d and data input connector 130 of OLED tile assembly 100a. The serial video and control data is then further transferred from OLED tile assembly 100a to OLED tile assembly 100b, via an electrical connection between data output connector 132 of OLED tile assembly 100a and data input connector 130 of OLED tile assembly 100b. In similar way, the serial video data and control data are subsequently transferred from OLED tile assembly 100b to OLED tile assembly 100e, from OLED tile assembly 100e to OLED tile assembly 100h, from OLED tile assembly 100h to OLED tile assembly 100j, from OLED tile assembly 100j to OLED tile assembly 100f and from OLED tile assembly 100f to OLED tile assembly 100c. In similar way, the daisy-chain method of power distribution is accomplished by AC power connections from one OLED tile assembly 100 to the next OLED tile assembly 100.

Although the latter method does not allow parallel distribution of the serial video and control data, i.e. distributing of serial video and control data occurs subsequently to a neighbouring tile, it can allow parallel, i.e. simultaneous, processing by the different OLED tile assemblies.

In FIGS. 5A and 5B, the same distribution method is used to distribute the power and the data. There is however no need to use the same method for data and power distribution.

The central system controller is aware of the X and Y configuration of each OLED tile assembly 100, i.e. its location in the array, in the tiled OLED display 500. High-level software addresses each OLED tile assembly 100 uniquely. At set-up, each OLED tile assembly 100 is assigned a unique number in the chain and picture co-ordinates are assigned accordingly. Once the configuration of tiled OLED display 500 is established at set-up, each OLED tile assembly 100 stores its information locally and thus the configuration process need not be repeated with each cycle of power. Only when the user reconfigures tiled OLED display 500 is it necessary to reassign OLED tile assemblies 100 to re-establish the picture co-ordinates.

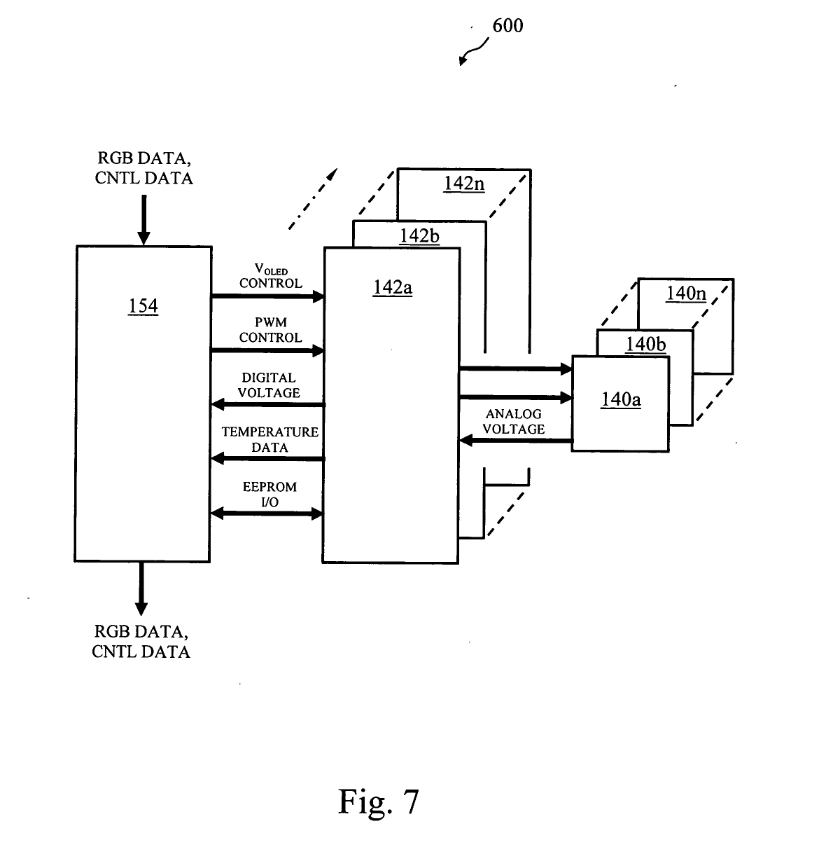

FIG. 6 illustrates a functional block diagram of an OLED tile control system 600 for use in an OLED tile assembly 100 in accordance with an embodiment of the present invention. OLED tile control system 600 performs the local processing and control functions needed to operate the n by m array of OLED module assemblies 138. FIG. 6 illustrates the physical distribution of the active functions across the combination of substrates 140, OLED boards 142, and control board 154, along with their electrical interconnections. More specifically, FIG. 6 illustrates that: a substrate 140a further includes an OLED array 612; an OLED board 142a further includes a plurality of bank switches 613, a plurality of current sources 614, an analog-to-digital (A/D) converter 622, an EEPROM 624, and a temperature sensor 628; and control board 154 further includes a tile processing unit 610, a bank switch controller 616, a constant current driver (CCD) controller 618, a pre-processor 620, and a module interface 626. Substrate 140a and OLED board 142a shown in FIG. 6 are representative of one of n by m substrates 140 and one of n by m OLED boards 142, as shown in FIG. 7.

The physical implementation of the functional blocks of each OLED board 142 and control board 154 may be via a custom application-specific integrated circuit (ASIC) device or a field-programmable gate array (FPGA) device, as is well known.

FIG. 6 illustrates that tile processing unit 610 is fed by an incoming red, green, blue data signal RGB DATA IN that is a serial data signal containing the current video frame information to be displayed on OLED tile assembly 100. Tile processing unit 610 subsequently buffers the incoming data signal RGB DATA IN and supplies an output data signal RGB DATA OUT of tile processing unit 610. Additionally, control data CNTL DATA from a general processor (not shown), such as a personal computer (PC) for example, that functions as the system-level controller of the OLED tile assembly 100 is supplied to tile processing unit 610 via a CNTL DATA bus. The CNTL DATA bus is a serial data bus that provides control information to OLED tile assembly 100, such as colour temperature, gamma, and imaging information. Tile processing unit 610 subsequently buffers the control data from the CNTL DATA bus for supplying an output control data signal to an outgoing CNTL DATA bus of tile processing unit 610. Tile processing unit 610 re-transmits the data signal RGB DATA IN and the control data on the CNTL DATA bus to the next OLED tile assembly 100 of a tiled OLED display 500, as shown in FIG. 5A and FIG. 5B.

Using the imaging information from the control data signal on the CNTL DATA bus, tile processing unit 610 stores the serial data signal RGB DATA IN for that particular frame that corresponds to either OLED tile assembly 100 being used as an autonomous display or by the physical position of a given OLED tile assembly 100 being used within a larger tiled display, such a tiled OLED display 500 of FIG. 5A or FIG. 5B.

In the case of tiled OLED display 500, tile processing unit 610 of each OLED tile assembly 100 associated with an OLED array in a tiled display 500 receives the data signal RGB DATA IN and subsequently parses this information into specific packets associated with the location of a given OLED tile assembly 100 within tiled OLED display 500. Algorithms running on tile processing unit 610 of each OLED tile assembly 100 facilitate the process of identifying the portion of the serial input data signal RGB DATA IN that belongs to its physical portion of tiled OLED display 500. Subsequently, tile processing unit 610 distributes a serial RGB signal RGB₍ₓ₎ to pre-processor 620, which RGB signal RGB₍ₓ₎ belongs to a physical portion of the tiled OLED display 500.

Similarly, tile processing unit 610 receives the control data on the control data bus CNTL DATA and subsequently parses this information into specific control buses associated with the location of a given OLED tile assembly 100 within tiled OLED display 500. Subsequently, tile processing unit 610 distributes a control signal CONTROL_{(X)} that provides control information, such as colour temperature, gamma, and imaging information, to OLED tile control system 600.

The elements of OLED tile control system 600 are electrically connected as follows. The RGB signal RGB_{(X)} from tile processing unit 610 feeds pre-processor 620; a control bus output BANK CONTROL of pre-processor 620 feeds bank switch controller 616; a control bus output CCD CONTROL of pre-processor 620 feeds CCD controller 618; a control bus output V_{OLED} CONTROL of bank switch controller 616 feeds bank switches 613 that are connected to the row lines of OLED array 612; and a pulse width modulation control bus output PWM CONTROL of CCD controller 618 feeds current sources 614 that are connected to the column lines of OLED array 612 via conventional active switch devices, such as MOSFET switches or transistors. A bus output ANALOG VOLTAGE of OLED array 612 feeds A/D converter 622; a bus output DIGITAL VOLTAGE of A/D converter 622 feeds module interface 626; and a bus output TEMPERATURE DATA of temperature sensor 628 feeds module interface 626. The control bus output CONTROL_{(X)} of tile processing unit 610 also feeds module interface 626. Furthermore, an input/output bus EEPROM I/O exists between EEPROM 624 and module interface 626; an input/output bus DATA I/O exists between pre-processor 620 and module interface 626; and, lastly, module interface 626 drives a data bus MODULE DATA_{(X)} to tile processing unit 610. Critical diagnostic information, such as temperature, ageing factors, and other colour correction data, is available to tile processing unit 610 via the data bus MODULE DATA_{(X)}.

A summary of the elements in the OLED tile control system 600 and their functions is provided below:

OLED array 612 includes a plurality of addressable discrete OLED devices, i.e., pixels. Those skilled in the art will appreciate that the OLED devices for forming a graphics display are typically arranged logically in rows and columns, as explained above, to form an OLED array, as is well known. OLED array 612 may be configured as a common-anode, passive-matrix OLED array. Bank switches 613 may be conventional active switch devices, such as MOSFET switches or transistors. Bank switches 613 connecting positive voltage sources to the rows of OLED array 612 are controlled by the control bus V_{OLED} CONTROL of bank switch controller 616. Current sources 614 may be conventional current sources capable of supplying a constant current, typically in the range of 5 to 50 mA. Examples of constant current devices include a Toshiba TB62705 (8-bit constant current LED driver with shift register and latch functions) and a Silicon Touch ST2226A (PWM-controlled constant current driver for LED displays). The active switches connecting current sources 614 to the columns of OLED array 612 are controlled by the control bus PWM CONTROL of CCD controller 618. OLED array 612 also provides feedback of the cathode voltages via the ANALOG VOLTAGE bus. OLED array 612 also provides feedback of the voltage value across each current source 614 via the bus ANALOG VOLTAGE.

Bank switch controller 616 contains a series of latches that store the active state of each bank switch 613 for a given frame. In this manner, random line addressing is possible, as opposed to conventional line addressing, which is consecutive. Furthermore, pre-processor 620 may update the values stored within bank switch controller 616 more than once per frame in order to make real-time corrections to the positive voltage +V_{OLED} driving a line of OLED pixels based on temperature and voltage information received during the frame. For example, an increase in temperature during a frame output may trigger a voltage reading command where bank switch controller 616 enables the positive voltage +V_{OLED} to the requested OLED devices within OLED array 612.

CCD controller 618 converts data from pre-processor 620 into PWM signals, i.e., the signals on the control bus PWM CONTROL, to drive current sources 614 that deliver varying amounts of current to the OLED devices or pixels within OLED array 612. The width of each pulse within the control bus PWM CONTROL dictates the amount of time a current source 614 associated with a given OLED device will be activated and deliver current. Additionally, CCD controller 618 sends information to each current source 614 regarding the amount of current to drive, which is typically in the range of 5 to 50 mA. The amount of current is determined from the brightness value, Y, for a given OLED device, which brightness value is calculated in pre-processor 620.

Pre-processor 620 develops local colour correction, ageing correction, black level, and gamma models (correction values may be stored in internal look-up tables (not shown) or in EEPROM 624) for the current video frame using information from module interface 626. Pre-processor 620 combines the RGB data of the RGB signal RGB_{(X)} describing the current frame of video to display with the newly developed colour correction algorithms and produces digital control signals, i.e., the signals on the buses BANK CONTROL and CCD CONTROL, for bank switch controller 616 and CCD controller 618, respectively. These signals dictate exactly which OLED devices within OLED array 612 to illuminate and at what intensity and colour temperature in order to produce the desired frame at the required resolution and colour-corrected levels. In general, the intensity, or greyscale value, is controlled by the amount of current used to drive an OLED device. Similarly, the colour temperature of the emitted light is controlled by the greyscale colour value and the relative proximity of each sub-pixel required to produce the desired colour. For example, a bright orange colour is produced by illuminating a green sub-pixel in close proximity to a brightly lit red sub-pixel. Therefore, it is important to have precise control over the brightness and the amount of time an OLED device is lit.

A/D converter 622 uses the analog voltage values, i.e., signals on the bus ANALOG VOLTAGE, from OLED array 612 to feed the voltage information back to module interface 626 via the bus DIGITAL VOLTAGE. The voltages across each OLED device within OLED array 612 (i.e., power supply voltage minus the cathode voltages) are monitored so that correct aging factors and light output values may be calculated in order to further produce the correct amounts of driving current through each OLED device within OLED array 612. Pre-processor 620 compares a pre-stored threshold voltage level for each OLED device within OLED array 612 with the voltage value measured by A/D converter 622 to determine whether digital voltage correction is plausible. If the voltage across a specific OLED device is below a maximum threshold voltage, digital correction may be implemented through colour correction algorithms. However, if the voltage is greater than the maximum threshold voltage, an adjustment must be made to the overall supply voltage. Digital voltage correction is preferred to supply voltage correction because it allows finer light output control for specific OLED devices within OLED array 612.

EEPROM 624 may be any type of electronically erasable storage medium for pervasively storing diagnostic and colour correction information. For example, EEPROM 624 may be a Xicor or Atmel model 24C16 or 24C164. EEPROM 624 holds the most recently calculated colour correction values used for a preceding video frame, specifically, gamma correction, ageing factor, colour co-ordinates, and temperature for each OLED module assembly 138. All factory and calibration settings may be stored in EEPROM 624 as well.

The gamma curves (either full gamma curves or parameters that define the curves in order to conserve storage space) for both light and dark values are stored in EEPROM 624 at start-up from the system-level controller via the control bus CONTROL_{(X)} from tile processing unit 610. Colour co-ordinates for each OLED device within OLED array 612 are also stored in EEPROM 624 in the form of (x,y,Y), where x and y are the co-ordinates of the primary emitters and Y is defined as the brightness.

The ageing factor of an OLED device is a value based on the total ON time, the temperature during that ON time, and total amount of current through each OLED device within OLED array 612. Other information may be stored in EEPROM 624 at any time without deviating from the spirit and scope of the present invention. Communication to EEPROM 624 is accomplished via the input/output bus EEPROM I/O. An advantage to locally storing colour correction and additional information specific to an OLED module assembly 138 on EEPROM 624 is that when new OLED module assemblies 138 are added to OLED tile assembly 100, or when OLED module assemblies 138 are rearranged within OLED tile assembly 100, valuable colour correction, ageing factors, and other details regarding the operation of OLED module assemblies 138 are also transported. Therefore, the new tile processing unit 610 is able to read the existing colour correction information specific to that OLED module assembly 138 from its local EEPROM 624 at any time and is able to make adjustments to the overall control of OLED tile assembly 100. This allows thus switching the OLED tiles without losing the necessary correction information.

Module interface 626 serves as an interface between tile processing unit 610 and all other elements within OLED boards 142. Module interface 626 collects the current temperature data from temperature sensor 628 and the current colour co-ordinate information (tri-stimulus values in the form of x,y,Y), ageing measurements, and runtime values from EEPROM 624 for each OLED device within OLED array 612. In addition, module interface 626 collects the digital voltage values during the ON time of each OLED device within OLED array 612 from A/D converter 622. Module interface 626 also receives control data, i.e., the signal on the control bus CONTROL_{(X)}, from tile processing unit 610, which dictates to pre-processor 620 how to perform colour correction (from a tile-level point of view) for the current video frame.

Temperature sensor 628 may be a conventional sensing device that takes temperature readings within OLED module assembly 138 to determine the temperature of the OLED devices within OLED module assembly 138. Accurate temperature readings are critical in order to correctly adjust for colour correction. Based on the temperature of each OLED device within OLED array 612, the current may be adjusted to compensate for the variation in light output caused by temperature. Temperature information from temperature sensor 628 is sent to module interface 626 for processing via the data bus TEMPERATURE DATA. An example temperature sensor 628 is an Analog Devices AD7416 device.

Embedded in an OLED tile assembly 100, the OLED tile control system 600—as well as other parts in the OLED tile assembly 100, e.g. the power supply of the OLED tile assembly 100 and additional cooling blocks provided as heat sinks e.g. at the back of the OLED array 612—are cooled by a cooling fluid, e.g. by airflow, as a result of the action of one or more cooling fans. These cooling fans can be conventional DC fans capable of providing a volume rate of airflow of between 2 and 5 cubic feet per minute (cfm) in order to maintain an operating temperature within the OLED tile assembly of between 10 and 50° C. An example of a cooling fan that can be used is a Delta Electronics model BFB0505M. The power supply of the OLED tile assembly 100 provides DC power to the cooling fans.

FIG. 7 illustrates the overall architecture of OLED tile control system 600 in accordance with the invention. FIG. 7 illustrates that a single control board 154 is designed to handle n by m OLED boards 142a to 142n and substrates 140a to 140n. Control board 154 is therefore customised depending upon the specific n by m configuration of OLED module assemblies 138 within a given OLED tile assembly 100. More specifically, a single control board 154 provides the signal fanout associated with the control bus V_{OLED} CONTROL, the control bus PWM CONTROL, the bus DIGITAL VOLTAGE, the data bus TEMPERATURE DATA, and the input/output bus EEPROM I/O to OLED boards 142a to 142n via connectors 152a to 152n, respectively.

With reference to FIGS. 1A through 7, the features and operation of OLED tile assembly 100 are generally described as follows.

Firstly, functionality is built into OLED tile assembly 100 that allows it to operate autonomously as a single display unit or alternatively within a set of OLED tile assemblies 100 forming a larger tiled display, such as tiled OLED display 500, all under the control of a central control system. To achieve this flexibility, each OLED tile assembly 100 includes, for example:
A digital video interface (i.e., tile processing unit 610) to handle all content (i.e., video) and communications information received. Content generation is e.g. via a DVI data stream of 24-bit RGB data (i.e., signal RGB DATA IN). Tile processing unit 610 handles the transfer of content data to each OLED module assembly 138. The communication link between OLED tile assembly 100 and the central control system is provided via standard RS-485 protocol (i.e., CNTL DATA bus).
An automatic addressing system, which is software based. Each OLED tile assembly 100 receives the same content data stream, but due to the addressing scheme, each OLED tile assembly 100 decodes which portion of the data to use and displays only that portion thereof based upon a predetermined co-ordinate address that is stored locally via each EEPROM 624.
A power supply (i.e., P/S 158) with a programmable regulated DC output.
A processor (i.e., tile processing unit 610) for performing real-time calculations for the various pixels, such as upscaling, downscaling, ON time calculations, light output calculation, lifetime correction, colour correction, pre-charge control, etc.; all to achieve a uniform image at the OLED module assembly 138 level.
A cooling system (i.e., see FIG. 2). More specifically, each OLED tile assembly 100 includes a set of cooling fans 160 and cooling blocks 146.
A diagnostic system, within which tile processing unit 610 handles the transfer of data to each OLED module assembly 138. For example, A/D converter 622 is used to monitor voltage thresholds (i.e., power supply voltage minus the cathode voltages) across each OLED device within OLED array 612, and temperature sensor 628 is used to measure the temperature within an OLED module assembly 138 or OLED tile assembly 100.

A first key aspect of OLED tile assembly 100 for use autonomously or alternatively within a set of OLED tile assemblies 100 is that distributed processing performs image upscaling or downscaling as necessary at each OLED tile assembly 100, rather than having a single central processor performing all of the scaling tasks. For example, instead of one central processor handling a 4K×4K resolution image and running all of the image scaling algorithms, each tile processing unit 610 (a simple video processor) of each OLED tile assembly 100 handles a small resolution image, such as 100×100 pixels. Furthermore, each tile processing unit 610 of each respective OLED tile assembly 100 is operating in parallel, thereby achieving very time-efficient processing. The parallel processing allows much more time for each OLED tile assembly 100 to calculate the image scaling, typically a 50 or 60 Hz timeframe. Thus, a very high-level scaling algorithm, e.g. bilinear or bicubic interpolation, is implemented very cost-effectively, which provides added value to the overall display system. Furthermore, instead of doing linear interpolation, this distributed processing technique allows the use of a slower 100% accurate scaling algorithm. An example calculation illustrating a comparison between non-distributed processing via a central processor and distributed processing via OLED tile assemblies 100 is as follows:

Real-time ON time calculation using non-distributed processing via a central processor
Supposing incoming active data: 1600×1200 pixels at 50 Hz.
PixelRate=50*1600*1200=96 MHz (minimum because of reduced blanking signal).
For real-time ON time calculations, a [3×3]×[3×1] matrix calculation for every pixel is performed. This [3×3]×[3×1] requires 3×3=9 multiplications and 3×3=9 additions, thus totalling 18 mathematical calculations.
Supposing every calculation requires one clock cycle, a calculation speed of 96 MHz×18=1.72 GHz is needed.

Real-time ON time calculation using distributed processing via OLED tile assemblies 100
Supposing each OLED module assembly 138 comprises 96×72 pixels.
A display of 1600×1200 pixels can be split into (1600/96)×(1200/72)=277 OLED tile assemblies 100.
Each OLED tile assembly 100 has to process 96×72=6912 pixels in one frame of 50 Hz, resulting in a processing speed of 6912×50=345 kHz.
Taking into account the multiplication of the matrix, a calculation speed of 345 kHz×18=6.2 MHz is needed.

A second key aspect of OLED tile assembly 100 for use autonomously or alternatively within a set of OLED tile assemblies 100 is that, because video stream is known, once the image scaling has been calculated, the ON time for each OLED may be calculated for a given OLED module assembly 138. This ON time is stored locally within EEPROM 624. This ON time in combination with the temperature measurement of OLED module assembly 138 and the voltage measurement of the OLED itself may be used to derive the lifetime of each OLED within a given OLED module assembly 138.

In summary, within OLED tile assembly 100, the information to potentially provide a 100% lifetime guarantee for OLED tile assembly 100 is available locally. The physical hardware implementation of OLED tile assembly 100 and the architecture of tiled OLED display 500 formed by a k by l array of OLED tile assemblies 100 provides distributed processing that has the result of a less complex display hardware and software system, thereby avoiding the need for high-bandwidth calculations by a central processor.

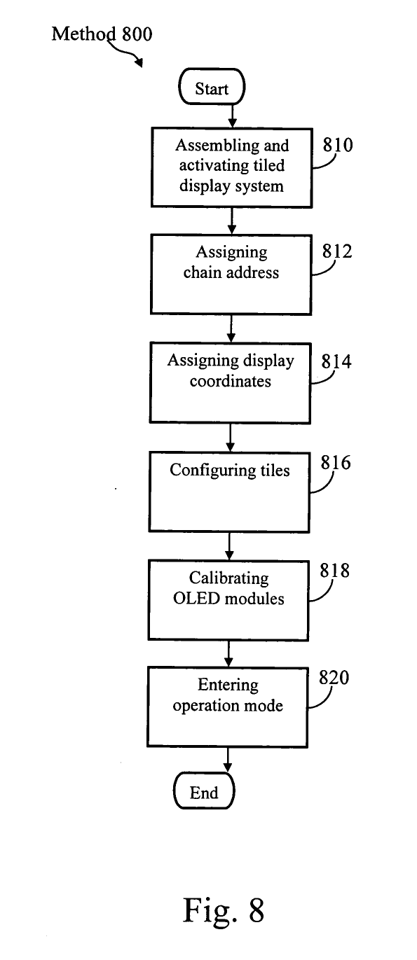

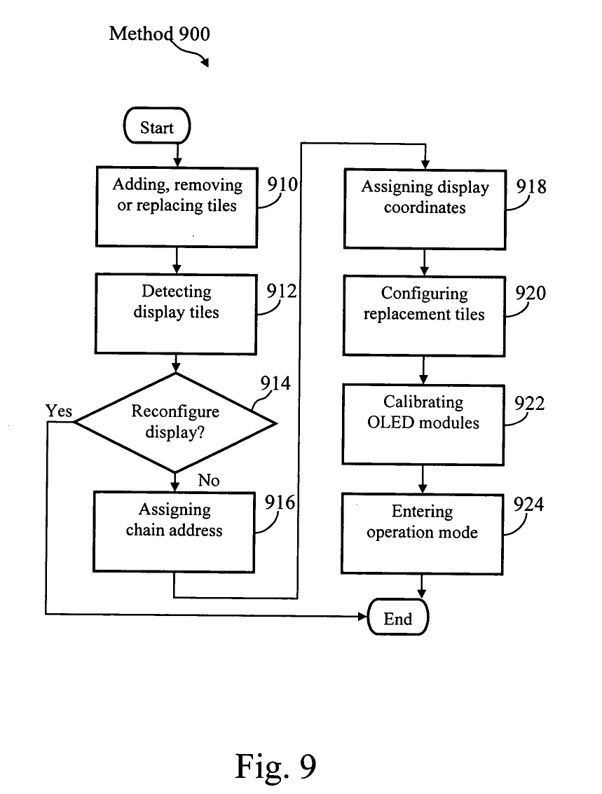

FIG. 8 is a flow diagram of a method 800 of initial assembly, automatic configuration, and calibration of tiled OLED display 500 in accordance with an embodiment of the present invention. FIGS. 1A through 7 are referenced throughout the steps of method 800. Method 800 includes the following steps:

Step 810: Assembling and Activating Tiled Display System

In this step, a plurality of OLED tile assemblies 100 are mechanically assembled in a k by l array, thereby forming a tiled OLED display such as tiled OLED display 500. Examples of data signal and power distribution methods are shown in FIG. 5A and FIG. 5B. Power is subsequently applied to each OLED tile assembly 100 of tiled OLED display 500. Method 800 proceeds to step 812.

Step 812: Assigning Chain Address

In this step, a central processor detects the presence of OLED tile assemblies 100 by systematically opening and closing switches to detect the presence and location of each OLED tile assembly 100 within tiled OLED display 500. The identification information of the OLED tile assembly 100 is read by an identification information determining means, such as e.g. an RS232 data interface. The switches used represent e.g. digital ‘AND’ functions. These are located in the data reclockers. The central processor subsequently assigns each OLED tile assembly 100 a unique address for use in steering content and communications data to each. Method 800 proceeds to step 814.

Step 814: Assigning Display Co-Ordinates

In this step, each OLED tile assembly 100 receives the display co-ordinates that designate what portion of the overall display it will show. Tile processing unit 610 of each OLED tile assembly 100 uses its display co-ordinates to automatically scale the incoming data to the resolution of OLED tile assembly 100. Method 800 proceeds to step 816.

Step 816: Configuring Tiles

In this step, the configuration data contained in EEPROM 624 within each OLED module assembly 138 is read by its associated tile processing unit 610. Each tile processing unit 610 uses this information to configure the resolution of its associated OLED tile assembly 100 according to the characteristics of its associated OLED module assemblies 138. Method 800 proceeds to step 818.

Step 818: Calibrating OLED Modules

In this step, each OLED module assembly 138 within each OLED tile assembly 100 is calibrated by setting the brightness value Y of each sub-pixel to the appropriate value, i.e. the value that allows realising the desired colour temperature and brightness. Calibration factors are set within each OLED tile assembly 100 so that every pixel within each OLED tile assembly 100 matches the overall display brightness and is colour-compensated to correct individual pixel non-uniformity. Method 800 proceeds to step 820.

Step 820: Entering Operation Mode

In this step, each tile processing unit 610 of each OLED tile assembly 100 within tiled OLED display 500 now receives global display parameters for normal operation from the central processor, thereby entering operation mode. Method 800 ends.

FIG. 9 is a flow diagram of a method 900 of replacing, adding, or removing one or more OLED tile assemblies 100 in tiled OLED display 500. FIGS. 1A through 7 are referenced throughout the steps of method 900. Method 900 includes the following steps:

Step 910: Adding, Removing, or Replacing Tiles

In this step, one or more OLED tile assemblies 100 of an existing tiled OLED display 500 are mechanically replaced, added, or removed. Additionally, existing OLED tile assemblies 100 within an existing tiled OLED display 500 may be reconfigured to form a tiled OLED display 500 of different dimensions than the original. Method 900 proceeds to step 912.

Step 912: Detecting Display Tiles

In this step, a central processor detects the presence of OLED tile assemblies 100 by systematically opening and closing switches to detect the presence and location of each OLED tile assembly 100 with tiled OLED display 500. Method 900 proceeds to step 914.

Step 914: Reconfigure Display?

In this decision step, using the information about OLED tile assemblies 100 detected in step 912, the central processor determines whether the number and arrangement of tiles has been altered. If yes, method 900 ends and method 800 is performed; if no, tiles have only been replaced and method 900 proceeds to step 916.

Step 916: Assigning Chain Address

In this step, the central processor detects the presence and location of each replacement or repositioned OLED tile assembly 100 and assigns a unique chain address for use in steering content and communications data to each. Method 900 proceeds to step 918.

Step 918: Assigning Display Co-Ordinates

In this step, each replacement OLED tile assembly 100 receives the display co-ordinates that designate what portion of the overall display it will show. Tile processing unit 610 of each OLED tile assembly 100 uses its display co-ordinates to automatically scale the incoming data to the resolution of OLED tile assembly 100. Method 900 proceeds to step 920.

Step 920: Configuring Replacement Tiles

In this step, the configuration data contained in EEPROM 624 in each tile processing unit 610 contained in each replacement OLED tile assembly 100 is read by tile processing unit 610. Each tile processing unit 610 uses this information to configure the resolution of its associated OLED tile assembly 100 according to the characteristics of its associated OLED module assemblies 138. Method 900 proceeds to step 922.

Step 922: Calibrating OLED Modules

In this step, each tile processing unit 610 within each replacement OLED tile assembly 100 is calibrated by setting the brightness value Y of each sub-pixel to the appropriate value, i.e. the value that allows realising the desired colour temperature, the desired brightness level and uniformity and the desired colour uniformity. Calibration factors are set within each OLED tile assembly 100 so that every pixel within each OLED tile assembly 100 matches the overall display brightness and is colour-compensated to correct individual pixel non-uniformity. Method 900 proceeds to step 924.

Step 924: Entering Operation Mode

In this step, each tile processing unit 610 of each OLED tile assembly 100 within tiled OLED display 500 now receives global display parameters for normal operation from the central processor, thereby entering operation mode. Method 900 ends.

1. A tiled emissive display (500) for displaying an image, the tiled emissive display (500) comprising a plurality of emissive display tile assemblies (100) mechanically coupled together, and a processing means for performing real-time calculations with respect to the image to be displayed,
wherein the processing means is a distributed processing means distributed over the plurality of emissive display tile assemblies (100), so that each emissive display tile assembly (100) is suitable for handling a different portion of the image for performing real-time calculations.

2. A tiled emissive display (500) according to claim 1, wherein the distributed processing means is suitable for performing image upscaling or downscaling at each emissive display tile assembly (100).

3. A tiled emissive display (500) according to claim 2, wherein for the image upscaling or downscaling a high-level scaling algorithm is used.

4. A tiled emissive display (500) according to claim 3, wherein the high-level scaling algorithm is a 100% accurate scaling algorithm.

5. A tiled emissive display (500) according to claim 1, wherein the distributed processing means of the plurality of emissive display tile assemblies (100) operate in parallel.

6. A tiled emissive display (500) according to claim 1, wherein an emissive display tile assembly (100) is provided with a data input and/or a data output connection for receiving data from or transmitting data to another emissive display tile assembly (100) via any of a multi-line connection, a daisy chain connection or a star connection.

7. A tiled emissive display (500) according to claim 1, wherein an emissive display tile assembly (100) is provided with a power input and/or a power output connection for receiving power from or transmitting power to another emissive display tile assembly (100) via any of a multi-line connection, a daisy chain connection or a star connection.

8. A tiled emissive display (500) according to claim 1, wherein an emissive display tile assembly (100) is provided with a connector allowing to combine both power and data transmission.

9. A tiled emissive display (500) according to claim 1, wherein each emissive display tile assembly (100) is provided with a local memory means for storing configuration data.

10. A tiled emissive display (500) according to claim 1, wherein an emissive display tile assembly (100) is adapted so that it can be repaired while the other tiles continue working.

11. A tiled emissive display (500) according to claim 1, wherein the tiled emissive display (500) has an adjustable size.

12. A method (800) of automatically configuring a tiled emissive display (500) comprising a plurality of emissive display tile assemblies (100) mechanically coupled together, the tiled emissive display (500) being intended for displaying an image, the method comprising
assigning (812) to each emissive display tile assembly (100) a unique address for use in steering content and communication data,
distributing (814) to each emissive display tile assembly (100) display co-ordinates that designate which portion of the image to be displayed it will show,
configuring (816) the emissive display tile assemblies (100) by reading, for each emissive display tile assembly (100), configuration data stored in a memory device (624) local to the emissive display tile assembly (100), and using this information in a distributed processing means (610) local to the emissive display tile assembly (100) to configure the resolution of the emissive display tile assembly (100).

13. A method according to claim 12, furthermore comprising, before assigning (812) to each emissive display tile assembly (100) a unique address, detecting the presence of the emissive display tile assemblies (100) in the tiled emissive display (500).

14. A method according to claim 12, furthermore comprising calibrating the emissive display tile assemblies (100) to match overall display brightness and/or to correct individual pixel non-uniformity.

15. A method according to claim 12, furthermore comprising, before assigning (812) to each emissive display tile assembly (100) a unique address, mechanically assembling and activating the tiled emissive display (500).

16. A method according to claim 15, wherein the mechanical assembling includes providing one of each of a daisy chain connection, a multi-line connection or a star connection for data and/or power from one emissive display tile assembly (100) to another.

17. A method of replacing at least one emissive display tile assembly (100) in a tiled emissive display (500) intended for displaying an image, the method comprising:
mechanically replacing (910) at least one emissive display tile assembly (100) in the tiled emissive display (500),
assigning (916) to the at least one replaced emissive display tile assembly (100) a unique address for use in steering content and communication data,
assigning (918) to the at least one replaced emissive display tile assembly (100) display co-ordinates that designate which portion of the image to be displayed it will show,
configuring (920) the at least one replaced emissive display tile assembly (100) by reading, for each replaced emissive display tile assembly (100), configuration data stored in a memory device (624) local to the at least one emissive display tile assembly (100), and using this information in a distributed processing means (610) local to the replaced emissive display tile assembly (100) to configure the resolution of the emissive display tile assembly (100).

18. A method according to claim 17, furthermore comprising calibrating the at least one replaced emissive display tile assembly (100) to match overall display brightness and/or to correct individual pixel non-uniformity.

19. A method according to claim 17, furthermore comprising, before assigning the unique address, determining (914) whether the number or arrangement of tiles has been altered.

20. A method according to claim 19, furthermore comprising, if the number or arrangement of the tiles has been altered, configuring the tiled emissive display (500) according to any of the methods according to claims 12 to 16.

21. A method according to claim 17, wherein mechanically replacing at least one emissive display tile assembly (100) includes restoring a distribution connection for data and/or power from or to at least one other emissive display tile assembly (100).

22. A tiled emissive display according to claim 1, wherein the display is an OLED display.

23. A method according to any of claims 12 or 17, wherein the emissive display is an OLED display.
